(19) United States
(12) Patent Application Publication
(10) Pub. No.: US 2025/0065977 A1
(43) Pub. Date: Feb. 27, 2025

(54) DRINKING HORN MOUNT FOR MOTORCYCLE

(71) Applicants: Rita Melissa Townley, Conroe, TX (US); Bobby Edward Reinbott, Salem, MO (US)

(72) Inventors: Rita Melissa Townley, Conroe, TX (US); Bobby Edward Reinbott, Salem, MO (US)

(21) Appl. No.: 18/236,979

(22) Filed: Aug. 23, 2023

(51) Int. Cl. B62K 19/40

(52) U.S. Cl. CPC B62K 19/40

(57) ABSTRACT

A drinking horn mount for securely and safely transporting a drinking horn on a motorcycle may include an upper portion configured to hold an upper portion of the drinking horn, wherein the upper portion may include a pair of loops configured to encircle an upper portion of a roll bar on the motorcycle; and an openable clip attached to the pair of loops, the openable clip configured to support a drinking horn holster; and a lower portion configured to hold a pointed end of the drinking horn, the lower portion configured to encircle a lower portion of the roll bar.

### BACKGROUND

The embodiments described herein relate generally to automotive accessories and, more particularly, to a drinking horn mount for a motorcycle.

Drinking horns are horn shaped drinking vessels that are historically associated with the Vikings. However, trying to hold or strap a drinking horn to a motorcycle is dangerous and awkward. There are no existing devices that are designed specifically to securely transfer a drinking horn when riding a motorcycle.

Therefore, what is needed is a drinking horn mount for securely and safely transporting a drinking horn while riding a motorcycle.

### SUMMARY

Some embodiments of the present disclosure include a drinking horn mount for securely and safely transporting a drinking horn on a motorcycle. The drinking horn mount may include an upper portion configured to hold an upper portion of the drinking horn, wherein the upper portion may include a pair of loops configured to encircle an upper portion of a roll bar on the motorcycle; and an openable clip attached to the pair of loops, the openable clip configured to support a drinking horn holster; and a lower portion configured to hold a pointed end of the drinking horn, the lower portion configured to encircle a lower portion of the roll bar.

### BRIEF DESCRIPTION OF THE FIGURES

The detailed description of some embodiments of the invention is made below with reference to the accompanying figures, wherein like numerals represent corresponding parts of the figures.

FIG. 1 is a rear perspective view of one embodiment of the present disclosure, shown in use.

FIG. 2 is an enlarged detail perspective view of one embodiment of the present disclosure, shown in use.

FIG. 3 is a front elevation view of one embodiment of the present disclosure.

FIG. 4 is a side elevation view of one embodiment of the present disclosure.

FIG. 5 is an exploded perspective view of one embodiment of the present disclosure.

FIG. 6 is a perspective view of the lower portion 30 of one embodiment of the present disclosure.

FIG. 7 is an exploded perspective view of the lower portion 30 of one embodiment of the present disclosure.

FIG. 8 is a rear perspective view of the upper portion 11 of one embodiment of the present disclosure.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used as a drinking horn mount for a motorcycle and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

The various elements of the present disclosure may be related in the following exemplary fashion. It is not intended to limit the scope or nature of the relationships between the various elements, and the following examples are presented as illustrative examples only.

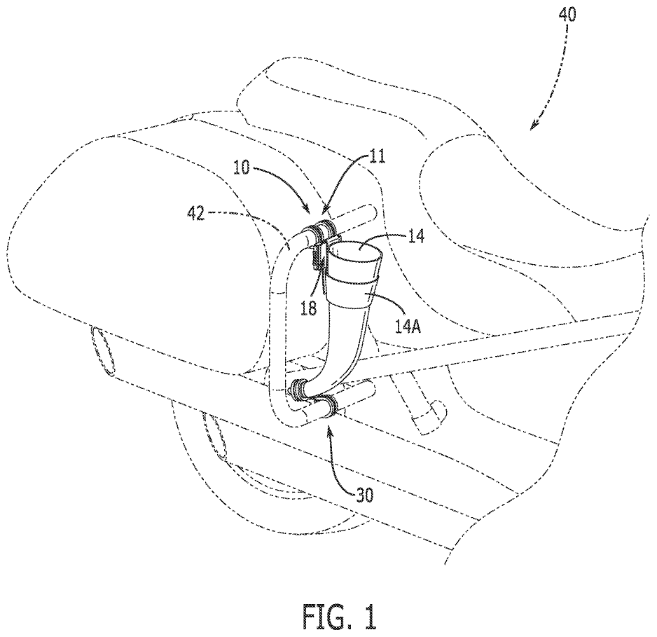

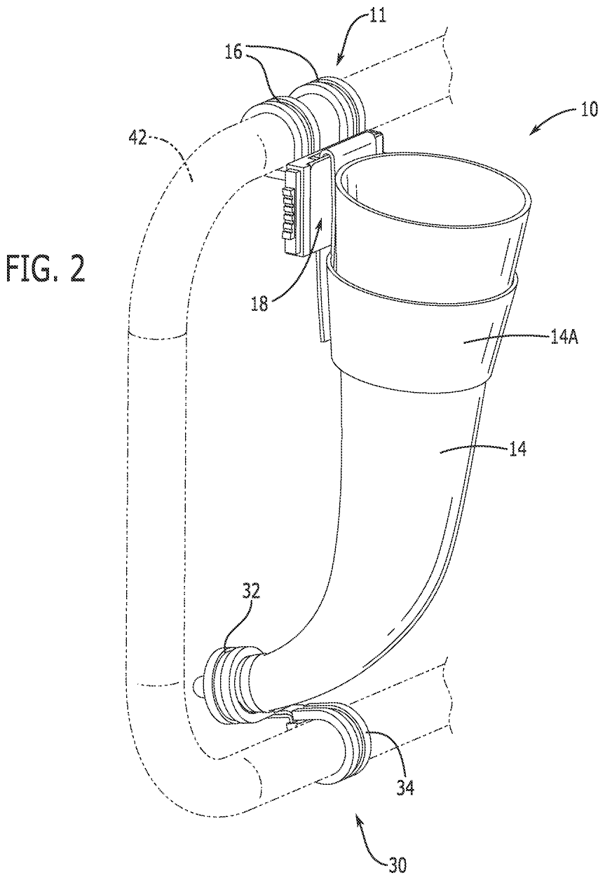

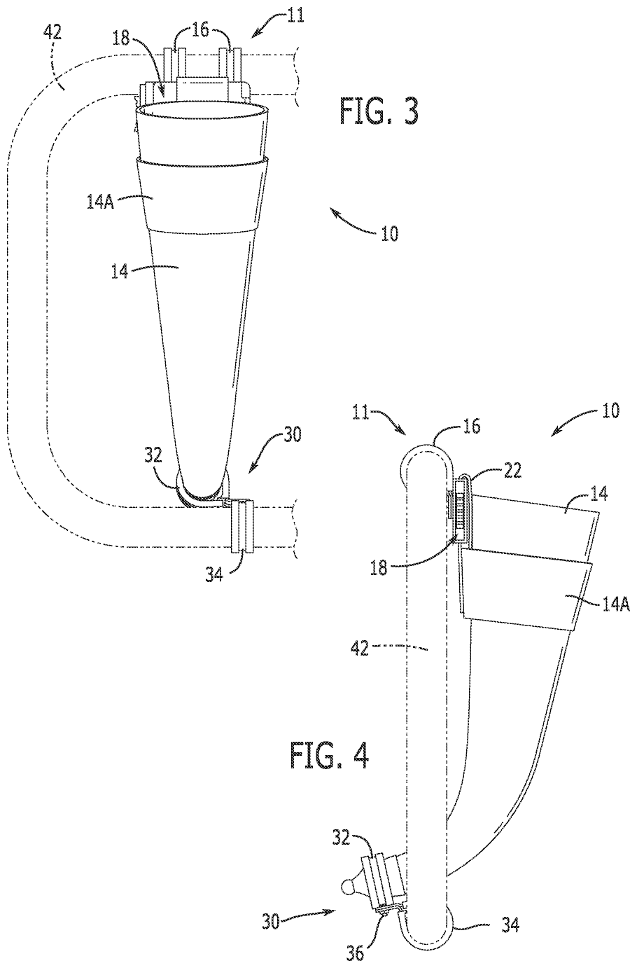

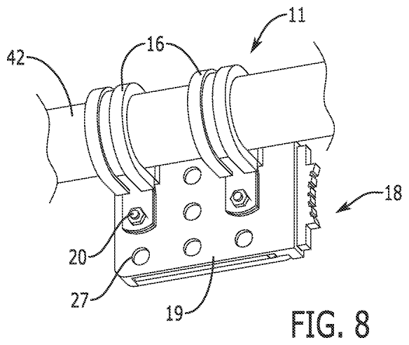

By way of example, and referring to FIGS. 1-8, some embodiments of the present disclosure include a drinking horn mount 10 for securely and safely transporting a drinking horn 14 on a motorcycle 40, the drinking horn mount 10 comprising an upper portion 11 configured to hold an upper portion of the drinking horn 14 and a lower portion 30 configured to hold a pointed end of the drinking horn 14, wherein each of the upper portion 11 and the lower portion 30 are configured to engage with a roll bar 42 on the motorcycle 40. The upper portion 11 may comprise a pair of loops 16 configured to encircle a top portion of the roll bar 42; and a clip 18 attached to the pair of loops 16, the clip 18 comprising a base plate 19 and a front plate 21 hingeably attached to the base plate 19, the clip 18 configured to hold a holster loop 22 on a holster 14A designed to hold the drinking horn 14A. The lower portion 30 may comprise a pair of lower loops comprising lower bar loop 34 configured to attach to a lower portion of the roll bar 42 and a lower horn loop 32 sized to accommodate insertion of the pointed end of the drinking horn 14 therein, wherein the lower bar loop 34 may be attached to the lower horn loop 32 by a fastener 36, wherein the opening in each loop is substantially perpendicular with respect to the other opening, as shown in FIGS. 6 and 7.

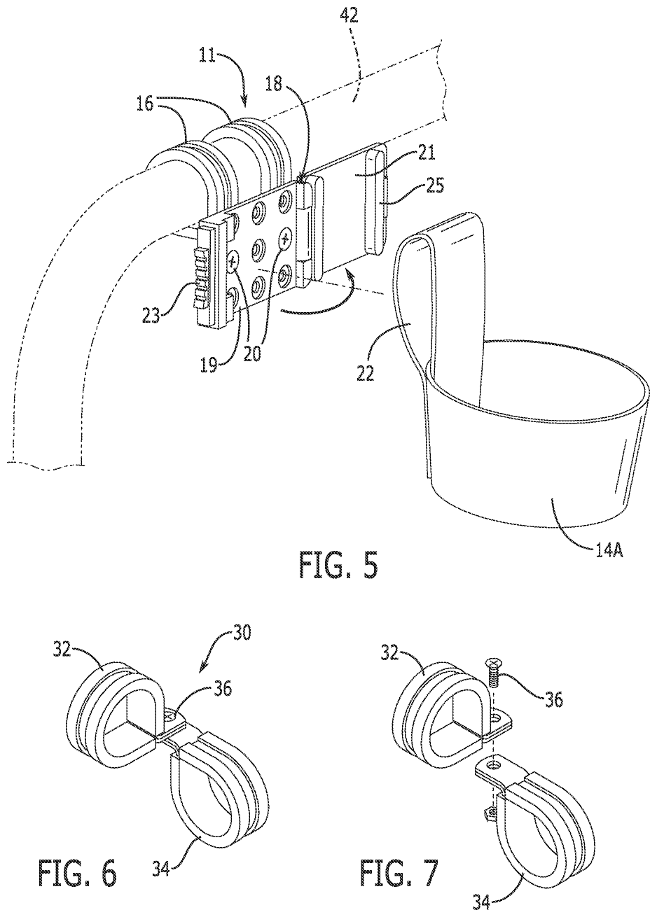

More specifically, and as shown in FIG. 5, the upper portion 11 may comprise two loops 16, wherein each of the loops 16 may comprise a strap or a clamp designed to secure around the roll bar 42. In a particular embodiment, the loops 16 may each comprise an insulated cable clamp secured around the roll bar 42 and to a back surface of the base plate using a fastener 20. More specifically, the loops 16 may each have a metal core with an outer protective covering, such as rubber or the like, wherein the ends of the metal core may have a fastener orifice extending therethrough. The loops 16 may be sized to securely and tightly encircle the roll bar 42. As mentioned above, the clip 18 may comprise a base plate 19 and a front plate 21 hingeably attached to the base plate 19, such that the front plate 21 may open and close with respect to the base plate 21. The front plate 21 may lock closed with respect to the base plate 19 by way of a distal edge 25 of the front plate 21 removably securing to a distal edge of the base plate 19. The distal edge of the base plate 19 may include a release mechanism 23, such as a button or slide, wherein the release mechanism 23 allows the distal edge 25 of the front plate 21 to disengage from the base plate 18. As shown in FIG. 5, the base plate 19 may have at least two fastener orifices 27 extending therethrough, wherein the fastener orifices 27 are each sized to accommodate insertion of a fastener 20, such as a bolt, therethrough, wherein the fastener 20 is also designed to engage with the loops 16. In some embodiments, the clip 18 may be similar in structure to a conventional tactical belt clip.

As discussed above, the lower portion 30 may comprise a lower bar loop 34 attached to a lower horn loop 32, wherein the lower bar loop 34 and the lower horn loop 32 are orthogonal to each other. Each of the lower horn loop 32 and the lower bar loop 34 may comprise a strap or a clamp designed to secure around the roll bar 42. In a particular embodiment, the loops 32, 34 may each comprise an insulated cable clamp secured around the roll bar 42 and to one another via a fastener 36. As shown, the loops may have a metal core with an outer protective covering wherein the ends of the metal core may have a fastener orifice extending therethrough, such that the loops 32, 34 may be engaged to one another simply by positioning a fastener 36, such as a bolt, through the fastener orifices.

To use the mount 10 of the present disclosure, the upper portion 11 may be attached to the upper portion of a roll bar 42 by wrapping the loops 16 around the roll bar and securing each loop to the back of the clip 18 using a respective fastener 20. The lower portion 30 of the mount 10 may also be attached to the lower portion of a roll bar 42, wherein the lower bar loop 34 may be positioned around the roll bar 42 and secured closed and to the lower horn loop 32 using a fastener 36. The clip 18 may be opened, allowing the front plate 21 to open with respect to the back plate 19. A holster 14A, which may comprise a drinking horn loop configured to encircle a larger end of the drinking horn 14 and a holster loop 22, may be removably engaged with the clip 18 by inserting the front plate 21 through the holster loop 22 and closing the front plate 21 with respect to the base plate 19. A drinking horn 14 may then be slid down into the drinking horn loop, allowing the point of the drinking horn to extend downward to the lower portion 30 of the mount 10. The pointed end of the drinking horn 14 may be inserted into the lower horn loop 32, thus securing the drinking born 14 to the mount 10. The user may remove the drinking horn 14 by simply pulling the larger end of the drinking horn 14 up and out of the drinking horn loop on the holster 14A. Alternatively, the user may release the front plate 21 from the base plate 19 using the release mechanism 23, allowing the user to still utilize the holster 14A with the drinking horn 14 separate from the mount 10.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

What is claimed is:

1. A drinking horn mount for securely and safely transporting a drinking horn on a motorcycle, the drinking horn mount comprising:
an upper portion configured to hold an upper portion of the drinking horn, wherein the upper portion comprises:
a pair of loops configured to encircle an upper portion of a roll bar on the motorcycle; and
an openable clip attached to the pair of loops, the openable clip configured to support a drinking horn holster; and
a lower portion configured to hold a pointed end of the drinking born, the lower portion configured to encircle a lower portion of the roll bar.

2. The drinking horn mount of claim 1, wherein the lower portion comprises:
a lower bar loop configured to encircle to the lower portion of the roll bar; and
a lower horn loop attached to the lower bar loop, the lower horn loop sized to accommodate insertion of the pointed end of the drinking horn therein.

3. The drinking horn mount of claim 2, wherein the lower bar loop and the lower horn loop each comprise a loop with a metal core with an outer protective covering.

4. The drinking horn mount of claim 2, wherein the lower bar loop is orthogonally positioned with respect to the lower horn loop.

5. The drinking horn mount of claim 1, wherein each loop of the pair of loops comprises a metal core with an outer protective covering.

6. The drinking horn mount of claim 1, wherein:
the openable clip comprises:
a base panel; and
a front panel hingeably attached to the base panel; and
the base panel has at least two fastener orifices extending therethrough.
